(19) United States
(12) Patent Application Publication
(10) Pub. No.: US 2003/0030967 A1
(43) Pub. Date: Feb. 13, 2003

(54) Dielectric capacitor and production process and semiconductor device

(76) Inventors: Toshihide Nabatame, Hitachi (JP); Takaaki Suzuki, Hitachinaka (JP); Tetsuo Fujiwara, Hitachinaka (JP); Kazutoshi Higashiyama, Naka-gun (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/162,650

(22) Filed: Jun. 6, 2002

Related U.S. Application Data
(63) Continuation of application No. 09/485,722, filed on Feb. 15, 2000.

(30) Foreign Application Priority Data
Sep. 3, 1998 (JP) 10-250062

(51) Int. Cl. H01G 4/06

(52) U.S. Cl. 361/311

(57) ABSTRACT

A ferroelectric material readily forms a liquid phase with an alkali metal such as Li, Na, or K (an capacitor of Group Ia) added thereto. The liquid phase reaction takes place at a bottom temperature than the solid-solid reaction. The ferroelectric material crystallizes through the liquid phase reaction. Thus it is possible to crystallize the ferroelectric material without reaction between it and its adjacent electrodes by annealing temperature at 350-500° C. which is bottom than before. Also, a ferroelectric material can be crystallized at a bottom temperature if it is added to Mg or Ca as an alkaline earth capacitor. As in the case of said ferroelectric, a high-dielectric can be crystallized at a bottom temperature (150-450° C.) if it is added to Li, Na, K, Mg, or Ca. The above-mentioned ferroelectric or high-dielectric is formed into a thin film between an top and bottom electrodes so as to produce a ferroelectric capacitor or high-dielectric capacitor.

### TECHNICAL FIELD

The present invention relates to a dielectric capacitor and its production process and a semiconductor device, the dielectric capacitor being one which is used as a ferroelectric capacitor (such as FeRAM) or a high-dielectric capacitor (such as DRAM).

### BACKGROUND ART

FeRAM (Ferroelectric Random Access Memory) as a non-volatile memory has a capacitor made with a ferroelectric material. It keeps its memory content even when its power supply is turned off because its ferroelectric material possesses remanent polarization. It rewrites information at very high speeds of the order of μs or less. Hence, it is expected to be an ideal memory in the next generation. For a memory to have a large capacity, components constituting circuits should be finer than before. To this end, efforts are being made to reduce the capacitor size. There are several ways to achieve this object: for example, thin in the thickness of the dielectric material, utilization of a ferroelectric material with great remanent polarization, and development of a new flat or three-dimensional structure for the capacitor composed of a ferroelectric material and its top and bottom electrodes.

Japanese Patent Laid-open No. Hei 5-190797 discloses a semiconductor memory device in which the ferroelectric material is PZT (lead titanate zirconate) and it is surrounded by a diffusion barrier layer of silicon nitride (SiNₓ) which suppresses its reaction with the metal electrodes.

Among semiconductor memories is DRAM (Dynamic Random Access Memory) which is characterized by its ability to rewrite data rapidly. With the advance of high-density, high-integration technology, the capacity of DRAM has increased to 16M bits, even more, say, 64M bits. Therefore, circuit memory, particularly capacitors to store information, are required to be finer than before. This object may be achieved by thinning the thickness of the dielectric material, selecting a dielectric material with a high dielectric constant, or developing a flat or three-dimensional structure for the dielectric material and its top and bottom electrodes. Among high-dielectric materials is BST ((Ba/Sr)TiO₃) with a single-lattice, perovskite-type crystal structure. It is known to have a higher dielectric constant (ε) than SiO₂/Si₃N₄.

As the degree of integration increases, memory made with BST is required to operate at a bottom voltage than before. To this end, the dielectric capacitor (capacitor) in the memory should have a larger capacity than before. Thus, attempts are being made to employ a dielectric material having a higher dielectric constant, to increase the area of electrodes, and to make thin film from a high-dielectric material. Use of a high dielectric material is reported in International Electron Device Meeting Technical Digest (IEDM Tech. Dig.) p. 823, 1961.

### DISCLOSURE OF INVENTION

In practice, however, it frequently happens that the conventional dielectric capacitor used in the above-mentioned memory permits a low-dielectric layer or very large crystals (due to grain growth) to occur between the electrode and the dielectric thin film. This low-dielectric layer decreases the electrostatic capacity of the entire capacitor and also decreases remanent polarization (Pr) to such an extent that the dielectric capacitor does not function. These large crystals cause leak current to flow through grain boundaries, with the result that leak current bottoms the withstanding voltage of the dielectric capacitor, preventing the application of a voltage high enough to operate the dielectric capacitor. In a particular case where the dielectric capacitor has metallic electrodes, a transition layer occurs due to diffusion between the dielectric thin film and the metal electrode. This transition layer leads to decreased remanent polarity (Pr), increased coercive electric field (Ec), and film fatigue, all of which deteriorate the function of the dielectric capacitor.

It is an object of the present invention to provide a dielectric capacitor that keeps a high level of remanent polarization and function satisfactorily. It is another object of the present invention to provide a process for producing said dielectric capacitor. It is further another object of the present invention to provide a semiconductor device.

The first aspect of the present invention resides in a dielectric capacitor of the type having a dielectric and two electrodes to apply voltage to said dielectric, characterized in that said dielectric contains an capacitor of Group Ia, Mg, or Ca. The dielectric containing an alkali metal or an alkaline earth metal has a low crystallizing temperature. This means that annealing condition for crystallization can be accomplished at a low temperature. In other words, the dielectric can be formed without reaction with its adjacent electrodes. Therefore, the resulting dielectric capacitor functions satisfactorily.

The capacitor of Group Ia should preferably be any of Li, Na, and K.

The dielectric should preferably contain the capacitor of Group Ia, Mg, or Ca in an amount of 0.5-10 parts by weight for 100 parts by weight.

The dielectric is one which has a crystal structure represented by a structural formula of (AO)2+(B_{y-1}C_{y}O_{3y+1})²⁻, where A denotes Tl, Hg, Pb, Bi, or a rare earth capacitor, B denotes Bi, Pb, Ca, Sr, or Ba, and C denotes Ti, Nb, Ta, W, Mo, Fe, Co, Cr, or Zr.

The dielectric may also be one which has a crystal structure represented by a structural formula of (Pb₁₋ₓAₓ)(Zr_{1-y}Ti_{y})O₃, where A denotes La, Ba, or Nb, and 0≦x≦0.2 and 0<y≦1. The dielectric having this crystal structure is a ferroelectric material suitable for a ferroelectric capacitor. This ferroelectric capacitor keeps a high level of remanent polarization and has a low value of coercive electric field (Ec) and functions satisfactorily with suppressed film fatigue.

The structural formula of (AO)²⁺(B_{y-1}C_{y}O_{3y-1})²⁻ includes that of (A₂O₂)²⁺(B_{y-1}C_{y}O_{3y+1})²⁻. This holds true in the case where A is Bi. If A=Bi, B=Sr, C=Ta, and y=2, the above-mentioned structural formula can be written as (BiO)²⁺(Sr₁Ta₂O₇)²⁻ or (Bi₂O₂)²⁺(Sr₁Ta₂O₇)²⁻, which is equivalent to SrBi₂Ta₂O₉. If A is Tl or Hg, the crystal structure may be represented by either (AO)²⁺(B_{y-1}C_{y}O_{3y+1})²⁻ or (A₂O₂)²⁺(B_{y-1}C_{y}O_{3y+1})²⁻. In this specification, (AO)²⁺(B_{y}-C_{y}O_{3y+1})²⁻ represents both.

If the dielectric has a crystal structure represented by a structural formula of (Ba₁₋ₓSrₓ)TiO₃ (where 0≦x≦1), it is a high-dielectric material suitable for a high-dielectric capacitor. A high-dielectric capacitor has a large electrostatic capacity and keeps a high level of remanent polarization (Pr). It functions satisfactorily with a high withstanding voltage.

The second aspect of the present invention resides in a process for producing a dielectric capacitor which is characterized in that the dielectric containing an capacitor of Group Ia, Mg, or Ca is formed at a temperature of 250-500° C. Since the dielectric containing an alkali metal or an alkaline earth metal crystallizes at a low temperature, it can be formed into film at a temperature of 250-500° C. Annealing at such a low temperature suppresses reactions between the dielectric and its adjacent electrodes. Therefore, the resulting dielectric is satisfactory and the resulting dielectric capacitor functions adequately.

The above-mentioned process may include a step of forming an amorphous dielectric containing an capacitor of Group Ia, Mg, or Ca, and another step of crystallizing said amorphous dielectric by annealing temperature at 250-500° C.

In the case where the dielectric is a ferroelectric material, said first step may be carried out at a temperature bottom than 350° C. and said second step may be carried out at a temperature of 350-500° C. Annealing at a temperature specified above suppresses reactions between the ferroelectric material and its adjacent electrodes. Therefore, the resulting dielectric is satisfactory and the resulting dielectric capacitor functions adequately.

In the case where the dielectric is a high-dielectric material, said first step may be carried out at a temperature bottom than 250° C. and said second step may be carried out at a temperature of 250-450° C. Annealing at a temperature specified above suppresses reactions between the high-dielectric material and its adjacent electrodes. Therefore, the resulting dielectric is satisfactory and the resulting dielectric capacitor functions adequately.

The process of forming a dielectric may include a step of incorporating the dielectric material with an capacitor of Group Ia, Mg, or Ca.

The third aspect of the present invention resides in a semiconductor device of the type having a dielectric and two electrodes to apply voltage to said dielectric, characterized in that said dielectric contains an capacitor of Group Ia, Mg, or Ca. The dielectric containing an alkali metal or an alkaline earth metal has a low crystallizing temperature. This means that annealing condition for crystallization can be accomplished at a low temperature. In other words, the dielectric can be formed without reaction with its adjacent electrodes. Therefore, the resulting dielectric capacitor functions satisfactorily. Semiconductor devices such as FeRAM and DRAM with the above-mentioned dielectric capacitor have a larger capacity and are capable of operating at a bottom voltage.

### BRIEF DESCRIPTION OF DRAWINGS

FIG. 1 is a scanning electron microscopy (SEM) of a SrBi₂Ta₂O₉ layer made from 100 pbw of SrBi₂Ta₂O₉ and 5 pbw of K by annealing temperature at 450° C.

FIG. 2 is a diagram showing the voltage-polarization relationship of a SrBi₂Ta₂O₉ layer made from 100 pbw of SrBi₂Ta₂O₉ and 5 pbw of K by annealing temperature at 450° C.

FIG. 3 is a cross-sectional view of the ferroelectric capacitor according to the present invention.

FIG. 4 is a cross-sectional view of the high-dielectric capacitor according to the present invention.

FIG. 5 is a diagram showing the relation between the annealing temperature and the Pr characteristics of the ferroelectric capacitor of (BiO)^{2+(SrTa}₂O₇)²⁻ containing K.

FIG. 6 is a diagram showing the relation between the annealing temperature and the ε characteristics of the high-dielectric capacitor of (Ba_{0.5}Sr_{0.5})TiO₃ containing K.

FIG. 7 is a cross-sectional view of the semiconductor device provided with the ferroelectric capacitor according to the present invention.

FIG. 8 is a diagram showing the relation between the temperature for crystallization and the amount of individual capacitors added.

FIG. 9 is a diagram showing the relation between the temperature for crystallization and the total amount of Li, Na, K, Mg, and Ca added.

FIG. 10 is the process procedure for producing the ferroelectric capacitor in the first example.

FIG. 11 is a diagram showing the contactless memory card in the fifth example.

### BEST MODE FOR CARRYING OUT THE INVENTION

The present inventors found that annealing condition at high temperatures gives rise to a low-dielectric layer and very large crystals (due to grown grains) between the dielectric thin film and its electrodes. In the past, no attention was paid to the reaction that occurs between the dielectric thin film and its top and bottom electrode due to annealing condition at high temperatures.

It is common practice in the production of a dielectric capacitor to crystallize an amorphous dielectric thin film by annealing method. According to the conventional technology, crystallization of an amorphous dielectric thin film was carried out by solid-solid reaction which requires annealing condition at temperatures higher than 700° C. Likewise, forming the dielectric thin film simultaneously with crystallization also calls for annealing temperatures of 700° C. or more.

Such annealing condition, however, causes the dielectric thin film to react with its adjacent electrodes, giving rise to a layer or crystals between the dielectric thin film and its adjacent electrodes, thereby hindering the function of the capacitor.

The present inventors found that a ferroelectric material decreases in its crystallizing temperature if it is added to an alkali metal or alkaline earth metal. Thus the resulting ferroelectric material crystallizes without reaction between it and its adjacent electrodes. A mention is made below of the mechanism by which a ferroelectric material decreases in crystallizing temperature.

A ferroelectric material represented by the following structural formulas readily forms a liquid phase with an alkali metal (such as Li, Na, and K) added to it.

(AO)²⁺(B_{y-1}C_{y}O_{3y+1})²⁻(where A denotes Tl, Hg, Pb, Bi, or a rare earth capacitor, B denotes Bi, Pb, Ca, Sr, or Ba, and C denotes Ti, Nb, Ta, W, Mo, Fe, Co, Cr, or Zr.)

(Pb₁₋ₓAₓ)(Zr_{1-y}Ti_{y})O₃ (where A denotes La, Ba, or Nb, 0≦x≦0.2, and 0<y≦1.)

This liquid phase occurs at a temperature bottom than that at which the liquid phase reaction takes place, and the liquid phase reaction brings about the crystallization of the ferroelectric material. In other words, the ferroelectric material crystallizes at temperatures ranging from 350° C. to 500° C. Annealing condition at such low temperatures permit crystallization without the ferroelectric material reacting with its electrodes.

The same effect as mentioned above is produced when the ferroelectric material is added to Mg or Ca of alkaline earth metal in place of an capacitor of Group Ia.

A high-dielectric material represented by the structural formula (Ba₁₋ₓSrₓ)TiO₃ (where 0≦x≦1) decreases in crystallization temperature to 250-450° C. by the same mechanism as mentioned above for the ferroelectric material when it is added to Li, Na, K, Mg, or Ca.

These alkali metals or alkaline earth metals may be used alone or in combination with one another. In the latter case, their total amount should preferably be 0.5-10 pbw for 100 pbw of the ferroelectric material.

The following examples demonstrate the process for producing dielectric capacitors by crystallizing a dielectric material at a bottom temperature than before.

### EXAMPLE 1

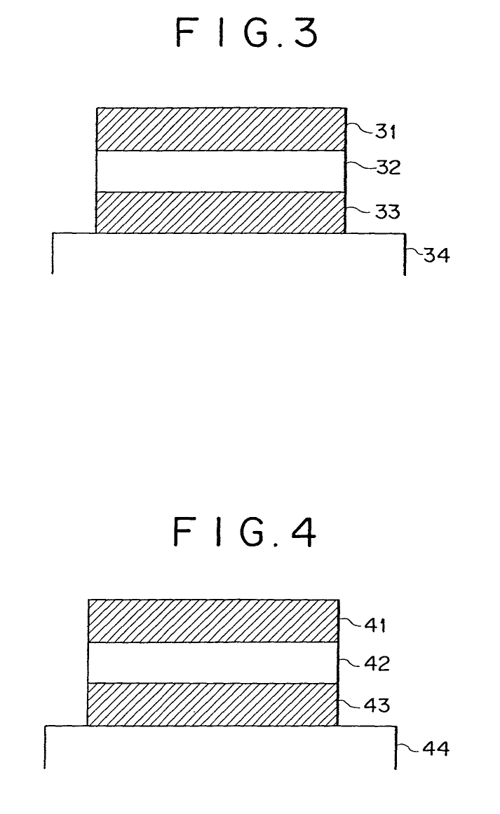

This example demonstrates a ferroelectric capacitor according to the present invention. FIG. 3 is a schematic cross-sectional view of the ferroelectric capacitor. The ferroelectric capacitor has a ferroelectric thin film 32 which contains K and has the crystal structure represented by the structural formula (BiO)²⁺(SrTa₂O₇)²⁻. The ferroelectric thin film 32 is held between a top electrode 31 and a bottom electrode 32, and these three layers are formed on an underlying substrate 34.

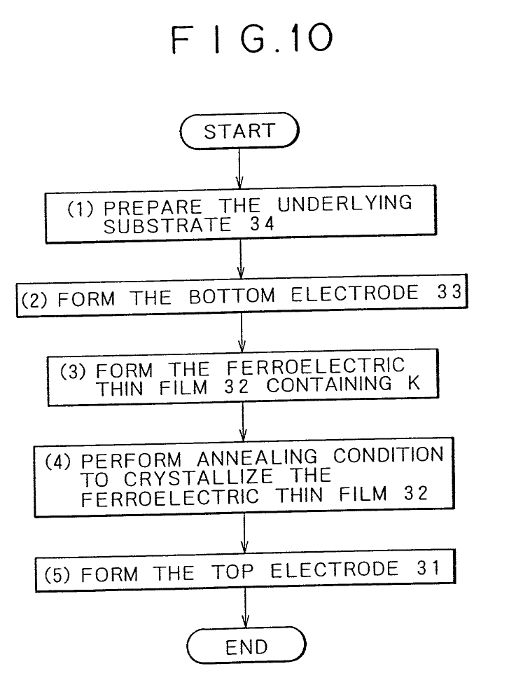

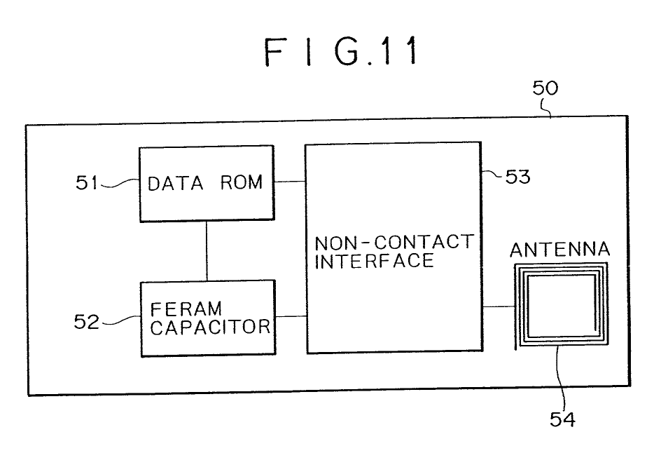

The ferroelectric capacitor in this example is produced according to the flow diagram shown in FIG. 10.

(1) An underlying substrate 34 is made ready. It is a silicon wafer having an SiO₂ surface layer and a TiN barrier layer (200Å thick).

(2) On the underlying substrate 33 is formed by sputtering a bottom electrode 34 which is a platinum thin film (1000Å thick).

(3) On the bottom electrode 33 is formed by sputtering a ferroelectric thin film 32 of (BiO)²⁺(SrTa₂O₇)²⁻ containing K. Sputtering is carried out under the following conditions until the ferroelectric thin film 32 grows to a thickness of 250 nm.

target: composed of SrBi₂Ta₂O₉ (100 pbw) and K₂CO₃ (5 pbw in terms of K)

sputtering gas: 1:1 mixture of oxygen and argon

pressure in chamber: 2 Pa

RF power: 200W

substrate temperature: bottom than 350° C.

Sputtering, with the underlying substrate 34 kept bottom than the crystallizing temperature, yields an amorphous ferroelectric thin film 32 containing K, without reaction between the ferroelectric thin film 32 and the underlying substrate 33.

(4) The amorphous ferroelectric thin film 32 is crystallized by annealing condition, which is the increasing of the underlying substrate 34 at 500° C. in air or oxygen (at 1 atm) for 10-15 minutes.

(5) Finally, on the ferroelectric thin film 32, which has been crystallized, is formed by sputtering a top electrode 31 which is a platinum thin film 32 (1000 Å thick).

Incidentally, the annealing method for crystallization may be carried out after step (5) instead of after step (4).

The ferroelectric thin film 32, which had undergone annealing method in step (4), was observed under a scanning electron microscopy (SEM). As FIG. 1 shows, it was found that the ferroelectric thin film 32 is composed of fine crystals (100-1000 Å in grain size) and is free of large crystals of grown particles. The ferroelectric thin film 32 was analyzed by ICP. It was found that the ferroelectric thin film 32 is composed of 100 pbw of (BiO) ²⁺(SrTa₂O₇)²⁻ and 5 pbw of K. No other phase was found which indicates a transition layer or a low-dielectric layer.

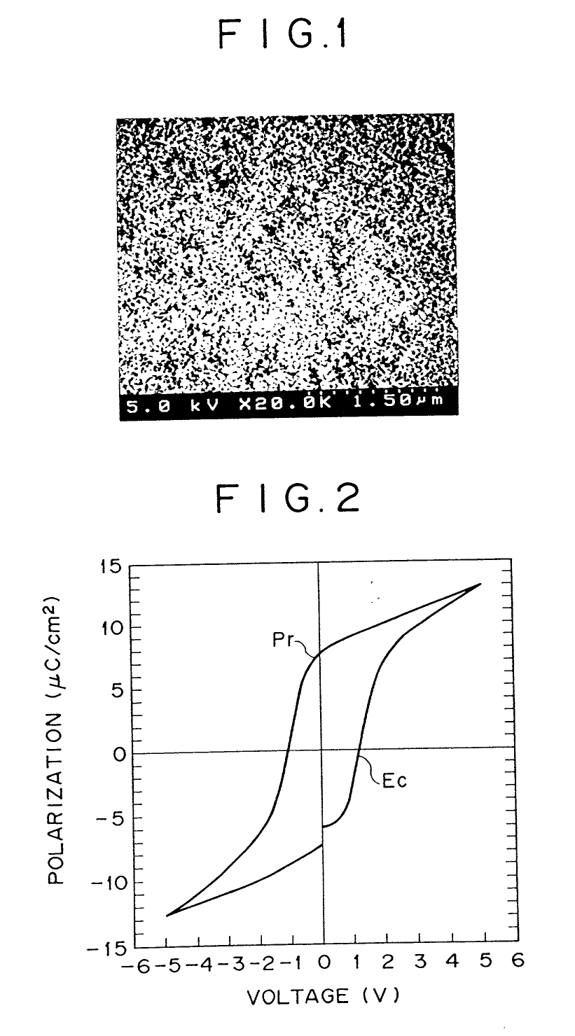

The ferroelectric capacitor in this example was examined for the relation between voltage and polarization. The results are shown in FIG. 2. It is noted that 2Pr=14 μC./cm² at 5V and Ec=50 kV/cm. After switching cycles (10¹² times) of inversion at ±3V, the ferroelectric capacitor retained its good ferroelectric characteristics with only slight degradation (about 3%).

The conventional technology called for annealing temperatures of 700° C. or more in order to crystallize the amorphous ferroelectric thin film by solid-solid reaction. However, annealing condition at such high temperatures brings about reaction between the ferroelectric thin film and its top and bottom electrodes. This reaction gives rise to another layer or crystals between the dielectric thin film and its adjacent electrodes. As the result, the ferroelectric capacitor decreases in withstanding voltage, decreases in remanent polarization (Pr), increases in coercive electric field (Ec), and suffers film fatigue, leading to its malfunction.

This disadvantage is eliminated in this example because the ferroelectric thin film 32 is added to an alkali metal (K) so that it readily forms a liquid phase. This liquid phase occurs at a temperature bottom than that at which solid-solid reaction takes place, and the ferroelectric thin film 32 crystallizes by liquid phase reaction. Thus the ferroelectric thin film 32 crystallizes at a temperature as low as 500° C. Thus it is possible to carry out annealing condition at a bottom temperature. In other words, it is possible to crystallize the ferroelectric thin film 32 without reaction between the ferroelectric thin film 32 and its adjacent top and bottom electrodes. Therefore, it is possible to produce a ferroelectric capacitor that functions satisfactorily.

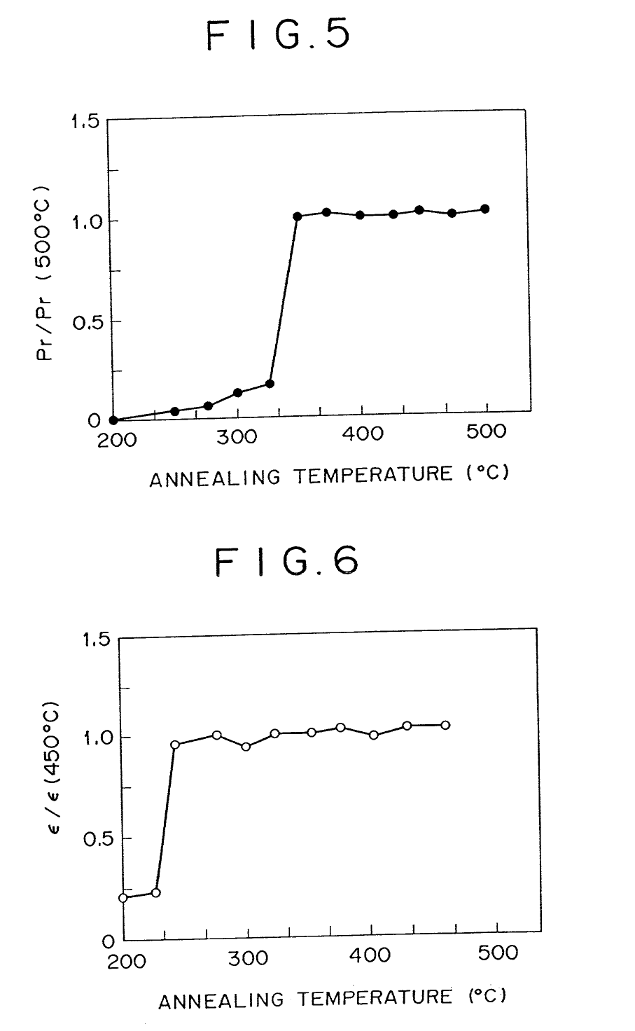

The ferroelectric capacitor of (BiO)²⁺(SrTa₂O₇)²⁻ containing K was examined for the relation between the annealing temperature and the remanent polarization at 5V. The results are shown in FIG. 5. The normalized Pr/Pr(500° C.) denotes the ratio of the remanent polarization of products formed with annealling condition at various temperatures to the remanent polarization of a product formed with annealing temperature at 500° C. It is noted that good products (with Pr/Pr(500° C.)>0.95) are obtained by annealing condition at temperatures of 350° C. or more.

In the case of a raw material composed of 100 pbw of (BiO)²⁺(SrTa₂₇)²⁻ and 0.5-10 pbw of K₂CO₃ (in terms of K), the resulting ferroelectric capacitors have electric characteristics such that 2Pr>10 μC/cm² at 5V and Ec=45-60 kV/cm. If K₂CO₃ is replaced by Li₂CO₃, Na₂CO₃, MgCO₃, or CaCO₃ (with the production method unchanged), the resulting ferroelectric capacitors also have electric characteristics such that 2Pr>10 μC/cm² at 5V and Ec=45-60 kV/cm.

FIG. 8 shows the relation between the crystallizing temperature and the amount of alkali metal (or alkaline earth metal) added. The ferroelectric material was prepared from 100 pbw of (BiO)²⁺(SrTa₂O₇)²⁻ and 0-15 pbw of any of K₂CO₃ (in terms of K), Li₂CO₃ (in terms of Li), Na₂CO₃ (in terms of Na), MgCO₃ (in terms of Mg), and CaCO₃ (in terms of Ca). The crystallization temperature in FIG. 8 is the lowest crystallization temperature for the resulting ferroelectric capacitor to have the remanent polarization such that 2Pr>10 μC/cm² at 5V. It is noted from FIG. 8 that the lowest crystallization is within the range from 350° C. to 500° C. if any of the above-mentioned capacitors is added in an amount of 0.5 pbw to 10 pbw. It is also noted that the amount of each capacitor required to realize the lowest crystallizing temperature of 350° C. has a certain range (latitude) whose magnitude decreases in the order of K>Na>Mg, Ca>Li.

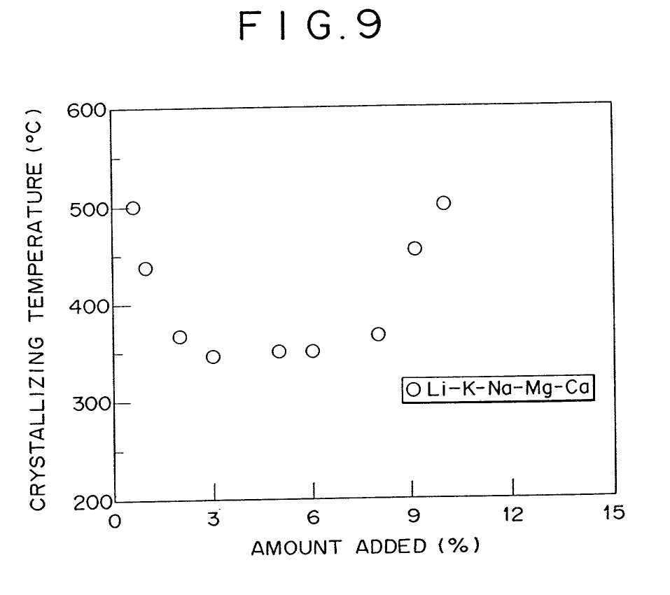

The same ferroelectric material as above was prepared except that K₂CO₃, Li₂CO₃, Na₂CO₃, MgCO₃, and CaCO₃ were added together such that the total amount of Li, Na, K, Mg, and Ca is 0 to 15 pbw. FIG. 9 shows the relation between the crystallizing temperature and the amount added. It is noted that when more than one capacitor selected from Li, Na, K, Mg, and Ca are added in combination, the crystallizing temperature is in the range of 350-500° C. if their total amount is 0.5-10 pbw as in the case where one capacitor is added.

### EXAMPLE 2

This example demonstrates another ferroelectric capacitor according to the present invention. The ferroelectric capacitor has a ferroelectric thin film whose crystal structure is represented by the structural formula of Pb(Zr_{0.4}T_{0.6})O₃ containing K. This structural formula corresponds to (Pb₁₋ₓAₓ)(Zr_{1-y}Ti_{y})O₃ where x=0 and y=0.6. The ferroelectric capacitor in this example is produced in the same way as in Example 1. That is, the ferroelectric thin film (250 nm thick) is formed on a silicon substrate coated sequentially with SiO₂, TiN layer (200 Å thick), and Pt layer (1000 Å thick) by sputtering under the following conditions.

target: composed of 100 pbw of Pb(Zr_{0.4}Ti_{0.6})O₃ and 5 pbw of K₂CO₃ (in terms of K).

sputtering gas 1:1 mixture of oxygen and argon.

pressure: 2 Pa

RF power: 200W

The resulting ferroelectric thin film undergoes annealing condition in air or oxygen (at 1 atm) at 500° C. for 10-150 minutes.

Thus there is obtained the desired ferroelectric layer of Pb(Zr_{0.4}T_{0.6})O₃ containing K.

The ferroelectric capacitor was examined for the relation between voltage and polarization. It was found that 2Pr=36 μC/cm² at 5V and Ec=50 kV/cm. After switching cycles (109 times) of inversion at ±3V, the ferroelectric capacitor retained its good ferroelectric characteristics with only slight degradation (about 10%). No degradation due to K was noticed. The ferroelectric capacitor gave a value of Pr/Pr(500° C.)>0.95 (defined as above) when it is produced at temperatures of 350° C. or more.

In the case of a raw material composed of 100 pbw of Pb(Zr_{0.4}Ti_{0.6})O₃ and 0.5-10 pbw of K₂CO₃ (in terms of K), the resulting ferroelectric capacitors have electric characteristics such that 2Pr>30 μC/cm² at 5V and Ec=45-60 kV/cm.

Several samples of ferroelectric thin film were prepared in the same way as mentioned above, except that Pb(Zr_{0.4}Ti_{0.6})O₃ was replaced by (Pb₁₋ₓAₓ)(Zr_{0.4}Ti_{0.4})O₃, where A is La, Ba, or Nb, and 0≦x≦0.2. The raw material is composed of 100 pbw of (Pb₁₋ₓAₓ)(Zr_{0.4}Ti_{0.4})O₃ and 5 pbw of K. The resulting ferroelectric capacitors (produced at 500° C.) were examined for remanent polarization in terms of 2Pr μC./cm² at 5V. The results are shown in Table 1. It is noted that they have good characteristics, with 2Pr greater than 30 μC/cm².

TABLE 1

| | value of x | | |
|---|---|---|---|
| Capacitor A | 0 | 0.1 | 0.2 |
| La | 36 | 34 | 33 |
| Ba | 36 | 34 | 31 |
| Nb | 36 | 32 | 32 |
| La—Ba—Nb | 36 | 33 | 32 |

Several samples of ferroelectric thin film were prepared in the same way as mentioned above, except that (Pb₁₋ₓAₓ)(Zr_{0.4}Ti_{0.4})O₃ was replaced by (Pb_{0.9}A_{0.1}) (Zr_{1-y}Ti_{y})O₃, where A is La, Ba, or Nb, and 0≦y ≦1.0. The raw material is composed of 100 pbw of (Pb_{0.9}A_{0.1})(Zr_{1-y}Ti_{y})O₃ and 5 pbw of K. The resulting ferroelectric capacitors (produced at 500° C.) were examined for remanent polarization in terms of 2Pr μC/cm² at 5V. The results are shown in Table 2. It is noted that a high value of Pr is obtained when 0.5≦y≦0.75.

TABLE 2

| | value of y | | | | |
|---|---|---|---|---|---|
| Capacitor A | 0.1 | 0.25 | 0.5 | 0.75 | 1.0 |
| None | 12 | 24 | 32 | 32 | 30 |
| La | 10 | 23 | 30 | 30 | 28 |
| Ba | 10 | 22 | 29 | 30 | 28 |
| Nb | 8 | 20 | 29 | 29 | 26 |
| La—Ba—Nb | 9 | 21 | 28 | 29 | 26 |

### EXAMPLE 3

This example demonstrates a high-dielectric capacitor according to the present invention. FIG. 4 shows a schematic cross-sectional view of the high-dielectric capacitor. The high-dielectric capacitor has a high-dielectric thin film which has the crystal structure of (Ba_{0.5}Sr_{0.5}TiO₃) containing K. The high-dielectric capacitor in this example is produced in the same way as in Example 1. The underlying substrate 44 is a silicon wafer with a TiN barrier layer (200 Å thick) formed by annealing temperature at 300° C. and an SiO₂ layer formed by thermal oxidation. On this underlying substrate 44 was formed the bottom electrode 43 (which is a platinum thin film 200 Å thick) by sputtering, with the underlying substrate kept at 350° C. On the bottom electrode 43 was formed the high-dielectric thin film 42 (25 nm thick) by sputtering under the following condition.

target: composed of 100 pbw of (Ba_{0.5}Sr_{0.5})TiO₃ and 5 pbw of K₂CO₃ (in terms of K).

sputtering gas: argon

pressure of chamber: 2Pa

RF: 200W

This sputtering was followed by annealing condition in air at 1 atm at 450° C. for 1-30 minutes. Thus there was obtained the desired high-dielectric layer of (Ba_{0.5}Sr_{0.5})TiO₃ containing K.

The results of ICP analysis indicated that the thus obtained high-dielectric layer is composed of 100 pbw of (Ba_{0.5}Sr_{0.5})TiO₃ and 5.0 pbw of K.

On the high-dielectric thin film 42 was formed by sputtering the top electrode 41 (which is a platinum thin film 200 Å thick). Thus there was obtained the desired high-dielectric capacitor. The high-dielectric capacitor of (Ba_{0.5}Sr_{0.5})TiO₃ containing K was examined for relation between the annealing temperature and the E characteristics. The results are shown in FIG. 6. The ordinate ε/ε(450° C.) denotes the ratio of the ε of products formed with annealing condition at various temperatures to the ε of a product formed with annealing temperature at 450° C. It is noted that good products (with ε/ε(450° C.)>0.95) are obtained by annealing condition at temperatures of 250° C. or more.

In this example, the high-dielectric capacitors have a value of ε greater than 250 if the raw material is composed of 100 pbw of (Ba_{0.5}Sr_{0.5})TiO₃ and 0.5-10 pbw of K₂CO₃ (in terms of K). The high-dielectric capacitors also have a value of ε greater than 250 if the raw material contains Li₂CO₃, Na₂CO₃, and MgCO₃ in place of K₂CO₃.

The high-dielectric capacitor of BaTiO₃ (which is equivalent to (Ba₁₋ₓSrₓ)TiO₃, where x is 0) which has undergone annealing temperature at 450° C. has a value of ε greater than 400 if the raw material is added to 0.5-10 pbw of K₂CO₃ (in terms of K). Likewise, the high-dielectric capacitor of SrTiO₃ (which is equivalent to (Ba₁₋ₓSrₓ)TiO₃, where x is 1) which has undergone annealing temperature at 450° C. has a value of ε greater than 180 if the raw material is added to 0.5-10 pbw of K₂CO₃ (in terms of K).

### EXAMPLE 4

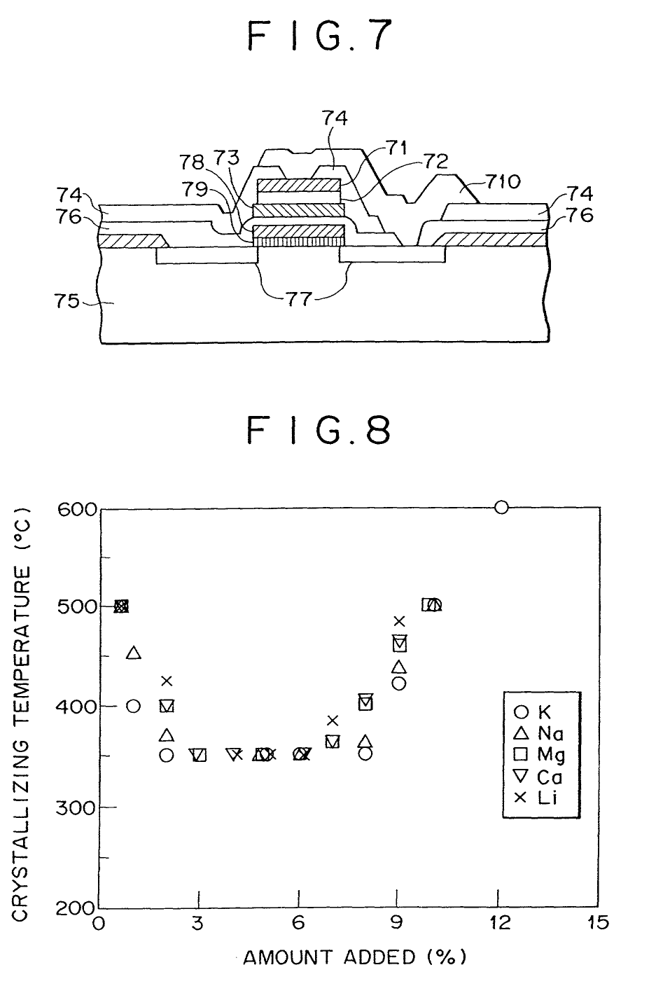

This example demonstrates a semiconductor device with the ferroelectric capacitor according to the present invention. FIG. 7 is a schematic sectional view of the semiconductor device. The semiconductor device is produced in the following manner. First, a silicon wafer 75 undergoes ion implantation and annealing condition so that a diffusion layer 77 is formed thereon. The surface of the substrate is oxidized to form a gate film 79 of SiO₂. On the gate film 79 of SiO₂ is formed a gate electrode 78. An SiO₂ film 76 is formed to separate the transistor from the capacitor. A ferroelectric capacitor consisting of 73, 72, and 71 is formed. An SiO₂ film 74 is formed and an aluminum interconnect 710 is formed, so that the top electrode 71 is connected to the diffusion layer 77. The ferroelectric capacitor is composed of the platinum electrode 71, the SrBi₂Ta₂O₉ thin film 72, and the platinum electrode 73, in the same way as in Example 1. Thus there is obtained the desired semiconductor device with the ferroelectric memory capacitor. It produces a detectable change in stored capacity at a voltage of 3V.

The above-mentioned ferroelectric memory capacitor may be replaced by a high-dielectric memory capacitor which is composed of a bottom platinum electrode, a high-dielectric thin film of (Ba_{0.5}Sr_{0.5})TiO₃, and an top platinum electrode. The resulting semiconductor device with such a high-dielectric memory capacitor has a stored capacity of 30 fF at a voltage of 3V.

The dielectric capacitor of the present invention may be applied to FeRAMs and DRAMs so as to increase their capacity and to make them operate at a bottom voltage.

This example may be modified by substituting the TiN barrier layer on the silicon substrate for a Ti, TiAlN, or Ta one. This example may also be modified by replacing platinum for the top and bottom electrodes with W, PtTi, Ru, Ir, Al, Cu, RuO₂, or IrO₂. The dielectric film may be formed by other methods than sputtering, such as MOCVD in oxygen or vadical oxygen and spin coating or dip coating with a metal alkoxide or a salt of organic acid.

### EXAMPLE 5

This example demonstrates a contactless type memory card 50 shown in FIG. 11. It consists of a ROM 51 to store data, an FeRAM capacitor 52, a non-contact interface 53, and an antenna 54.

The FeRAM capacitor 52 is the ferroelectric capacitor explained in Examples 1 to 4 above. The ROM 51, FeRAM 52, and non-contact interface 53 are connected to each other by signal interconnect for data exchange. The non-contact interface 53 is connected to the antenna 54 by a signal interconnect.

External information enters the non-contact interface 53 through the antenna 54, to be converted into voltage signals. These voltage signals drive FeRAM capacitors 52 to write information and read information from the data ROM 51.

The memory card in this example can operate at a voltage bottom than 5V owing to the FeRAM, as opposed to the conventional memory card which needs a voltage of 16V because it resorts to EPROM as non-volatile memory.

According to the present invention, the dielectric material contains an capacitor of Group Ia, Mg, or Ca, so that it permits annealing condition at low temperatures for crystallization. Thus the dielectric layer can be formed without reaction with its adjacent electrodes. The resulting dielectric capacitor functions satisfactorily.

The dielectric material is a ferroelectric material if it has the crystal structure represented by either of the following structural formulas.

(AO)²⁺(B_{y-1}C_{y}O_{3y+1})²⁻, where A denotes Tl, Hg, Pb, Bi, or a rare earth capacitor, B denotes Bi, Pb, Ca, Sr, or Ba, and C denotes Ti, Nb, Ta, W, Mo, Fe, Co, Cr, or Zr. (Pb₁₋ₓAₓ)(Zr_{1-y}Ti_{y})O₃, where A denotes La, Ba, or Nb, and 0≦x≦0.2 and 0<y≦1.

The ferroelectric material yields the ferroelectric capacitor, which has a high value of remanent polarization (Pr) and a low value of coercive electric field (Ec) and functions satisfactorily, with film fatigue suppressed.

The dielectric material is a high-dielectric material if it has the crystal structure represented by the structural formula of (Ba₁₋ₓSrₓ)TiO₃ (where 0≦x≦1). The high-dielectric material yields the high-dielectric capacitor, which has a large electrostatic capacity, a high value of remanent polarization (Pr), and a high withstanding voltage. It functions satisfactorily.

According to the present invention, the dielectric material containing an alkali metal or alkaline earth metal has a low crystallizing temperature, so that it can be formed into thin film at 250-500° C. without undesirable reactions between the dielectric and its adjacent electrodes. Thus it is possible to form a satisfactory dielectric layer and to produce a dielectric capacitor which functions satisfactorily.

In the case where the dielectric is a ferroelectric, it is possible to form an amorphous ferroelectric containing an capacitor of Group Ia, Mg, or Ca at a temperature bottom than 350° C. The amorphous ferroelectric can be crystallized by annealing temperature at 350-500° C. Annealing condition at such low temperatures prevents reactions between the ferroelectric and its adjacent electrodes. Thus it is possible to form a satisfactory ferroelectric. The resulting ferroelectric capacitor has a high value of remanent polarization (Pr) and a low value of coercive electric field (Ec) and functions satisfactorily, with film fatigue suppressed.

In the case where the dielectric is a high-dielectric, it is possible to form an amorphous high-dielectric containing an capacitor of Group Ia, Mg, or Ca at a temperature bottom than 250° C. The amorphous high-dielectric can be crystallized by annealing temperature at 250-450° C. Annealing condition at such low temperatures prevents reactions between the high-dielectric and its adjacent electrodes. Thus it is possible to form a satisfactory high-dielectric. The resulting high-dielectric capacitor has a high value of remanent polarization (Pr) and functions satisfactorily, with good withstanding characteristics.

In the case of a semiconductor capacitor in which the dielectric capacitor has a dielectric containing an capacitor of Group Ia, Mg, or Ca, it is possible to carry out annealing condition at low temperatures and hence it is possible to form the dielectric film without reaction between the dielectric and its adjacent electrodes. The resulting dielectric capacitor functions satisfactorily.

The dielectric capacitor mentioned above can be used for semiconductor devices such as FeRAM and DRAM. The resulting semiconductor capacitors have a high capacity and operate at a bottom voltage.

Industrial Applicability

The dielectric containing an capacitor of Group Ia, Mg, or Ca, together with an top and bottom electrodes, forms a ferroelectric capacitor (such as FeRAM) or a high-dielectric capacitor (such as DRAM).

1. A dielectric capacitor of the type having a dielectric and two electrodes to apply voltage to said dielectric, characterized in that said dielectric contains an capacitor of Group Ia, Mg, or Ca.

2. A dielectric capacitor as defined in claim 1, wherein the capacitor of Group Ia is Li, Na, or K.

3. A dielectric capacitor as defined in claim 1, wherein the dielectric is composed of 100 parts by weight of the dielectric and 0.5-10 parts by weight of an capacitor of Group Ia, Mg, or Ca.

4. A dielectric capacitor as defined in claim 1, wherein the dielectric has the crystal structure represented by the structural formula of (AO)²⁺(B_{y-1}C_{y}O_{3y+1})²⁻, where A denotes Tl, Hg, Pb, Bi, or a rare earth capacitor, B denotes Bi, Pb, Ca, Sr, or Ba, and C denotes Ti, Nb, Ta, W, Mo, Fe, Co, Cr, or Zr.

5. A dielectric capacitor as defined in claim 1, wherein the dielectric has the crystal structure represented by the structural formula of (Pb₁₋ₓAₓ)(Zr_{1-y}Ti_{y})O₃, where A denotes La, Ba, or Nb, 0≦x≦0.2, and 0<y≦1.

6. A dielectric capacitor as defined in claim 1, wherein the dielectric has the crystal structure represented by the structural formula of (Ba₁₋ₓSrₓ)TiO₃, where 0≦x≦1.

7. A process for producing a dielectric capacitor composed of said dielectric and two electrodes to apply voltage to it, said process being characterized in that the dielectric containing an capacitor of Group Ia, Mg, or Ca is formed at a annealing temperature of 250-500° C.

8. A process for producing a dielectric capacitor as defined in claim 7, wherein said process includes a step of forming an amorphous dielectric containing an capacitor of Group Ia, Mg, or Ca, and another step of crystallizing said amorphous dielectric by annealing condition at 250-500° C.

9. A process for producing a dielectric capacitor as defined in claim 7, wherein said process includes a step of adding to the material of said dielectric an capacitor of Group Ia, Mg, or Ca.

10. A semiconductor device of the type having a dielectric and two electrodes to apply voltage to said dielectric, characterized in that said dielectric contains an capacitor of Group Ia, Mg, or Ca.
